(19) United States
(12) Patent Application Publication
(10) Pub. No.: US 2022/0171796 A1
(43) Pub. Date: Jun. 2, 2022

(54) SHIP WANDERING DETECTION METHOD BASED ON AIS DATA

(71) Applicant: Nanjing Beidou Innovation and Application Technology Research Institute Co., Ltd., Nanjing (CN)

(72) Inventors: Zhiqiang DU, Nanjing (CN); Wei GUO, Nanjing (CN); Baoqi YAN, Nanjing (CN); Yaxin FAN, Nanjing (CN)

(73) Assignee: Nanjing Beidou Innovation and Application Technology Research Institute Co., Ltd., Nanjing (CN)

(21) Appl. No.: 17/672,853

(22) Filed: Feb. 16, 2022

Related U.S. Application Data
(63) Continuation of application No. PCT/CN2021/112240, filed on Aug. 12, 2021.

(30) Foreign Application Priority Data
Sep. 29, 2020 (CN) 2020110472112

(51) Int. Cl. G06F 16/29; B60R 25/102

(52) U.S. Cl. CPC G06F 16/29; B60R 2025/1016; B60R 25/102

(57) ABSTRACT

The present invention discloses a ship wandering detection method based on AIS (Automatic Identification System) data. According to acquired AIS trajectory data of a ship, wandering behaviors of the ship are detected according to the massive trajectory data, the wandering behaviors of the ship are classified, and relationships between trajectories of four typical abnormal movement behaviors of the ship and defined variables are summarized. The detection for the wandering behaviors of the ship can provide decision support for maritime safety supervision, so as to enhance the safety of maritime traffic and ensure the safe navigation of the ship, which has great significance to promote the safety, efficiency and smoothness of maritime transportation.

### CROSS-REFERENCE TO RELATED APPLICATIONS

The application claims priority to Chinese patent application No. 2020110472112, filed on Sep. 29, 2020, the entire contents of which are incorporated herein by reference.

### TECHNICAL FIELD

The present invention relates to the field of big data analysis, and particularly relates to a ship wandering detection method based on AIS (Automatic Identification System) data.

### BACKGROUND

In recent years, with the increasing number and density of ships at sea, the trajectory data of the ships increases on a large scale, and meanwhile, the difficulty in maritime traffic safety management is also increasing day by day. It is necessary to analyze and process the trajectory data of the ships in a deeper level, so as to enhance the safety of maritime traffic. At present, more and more scholars use data information provided by equipment of an AIS to conduct maritime traffic researches.

According to movement trajectory behaviors of the ships, when non-fishing ships have similar wandering behaviors, the abnormal behaviors are often related to drunk driving, hijacking, illegal fishing, piracy, illegal measurement and so on. Then the length of a trajectory in a certain range is apparently higher than the normal condition. The traditional detection for the wandering behaviors of the ships is not targeted enough, and the abnormal behaviors of the ships cannot be detected in classification, such as approximate elliptical wandering trajectories of the ships, back and forth trajectories of the ships and so on. There is also a lack of processing methods for massive data in the analysis and processing for the trajectory data of the ships. The whole process is time-consuming and energy-consuming, and results of data processing lack objectivity and reliability.

### SUMMARY

In order to solve the above problems, the present invention aims to provide a ship wandering detection method based on AIS (Automatic Identification System) data. According to acquired AIS trajectory data of a ship, wandering behaviors of the ship can be detected according to the massive trajectory data, the wandering behaviors of the ship are classified, and relationships between trajectories of four typical abnormal movement behaviors of the ship and above defined variables are summarized According to an analysis on relationships between the characteristics of the movement trajectories of the ship and statistical parameters, the abnormal wandering behaviors of the ship are detected according to the distribution of the trajectories in grids.

In order to achieve the above purposes, the ship wandering detection method adopts the following technical solution:

The ship wandering detection method comprises the following steps:

S1: acquiring a space range of a key research area, i.e. a longitude and latitude range;

S2: calculating a grid code area covered by the space range according to the longitude and the latitude of the space range after the space range of the key research area is determined and obtaining a grid code set (u₁, u₂, . . . , uₙ) in the space range;

S3: calculating and outputting a row and column number range ({uminₘₐₓ, {vminₘₐₓ)}} according to the grid code range;

S4: screening original movement trajectories of the ship, acquiring trajectory data in a set time range and a set space range and converting a result data set into a corresponding grid code set;

S5: traversing the grid code set of the movement trajectory of the ship and counting the valid grid quantity nValid in the set;

S6: determining the range of the valid grids in each row according to the row and column number range, i.e., the grid code range with a valid counting variable more than or equal to 1, and calculating the approximate area s;

S7: calculating the row number and the column number of the center of the trajectory by the grid codes of the trajectory of the ship, determining the grid code of the center of the trajectory and auxiliarily judging the specific shape of the trajectory;

S8: calculating the length of the trajectory, wherein the total length of the movement trajectory of the ship is the sum of all valid grid counting variables; and

S9: the length nₛᵤₘ of the trajectory of the ship is less than twice the sum of the quantities of rows and columns of the grids in the space range of the key area; and if nₛᵤₘ is more than the threshold, judging that the trajectory is an abnormal trajectory.

Further, wherein the step S5 comprises: judging that whether grid codes in the set have repeating value, and if the same codes exist in different time nodes, adding 1 into the count of the grids; and outputting a result set after the judging circulation is completed, wherein the length of the set is the valid grid quantity.

Further, wherein the step S6 comprises acquiring the code range in the range of each row, finding out the maximum value and the minimum value of the valid counting variable n, calculating the difference between the maximum u and the minimum u in each row, adding 1 into the difference and summing results of all rows to obtain the approximate area sₐᵣₑₐ calculated according to the rows; then, calculating the grids in each column in the research area in the same manner, acquiring a calculation result of each column and summing the calculation results to obtain the approximate area s_{areac} of the trajectory, which is calculated according to the columns; and finally, obtaining the approximate area which is an average value of the two approximate areas: s=(sₐᵣₑₐₗ s_{areac})/2.

Further, wherein in the step S9, when the quantity n_{(>2)} of the grids with the valid counting variable more than 2 is equal to 0, judging that the ship is doing the approximate S-shaped curve movement possibly; when ñ is more than 15, and s−n (valid) is more than 20, judging that the trajectory is the elliptical trajectory possibly; when ñ is less than 8, and s−n (valid) is less than 10, judging that the trajectory is the back and forth trajectory possibly; when the length nₛᵤₘ of the trajectory of the ship is equal to n (valid), determining that the trajectory is the approximate S-shaped curve; and if the length nₛᵤₘ of the trajectory of the ship is more than twice the sum of the quantities of rows and columns of the grids in the space range of the key area, but does not belong to the above situations, when n (valid) is more than (p+q)/4, judging that the ship is doing the irregular broken line movement.

The ship wandering detection method has the following beneficial effects:

The present invention provides the ship wandering detection method based on the AIS data. Compared with the prior art, in the ship wandering detection method, according to the acquired AIS trajectory data of the ship, the wandering behaviors of the ship can be detected according to the massive trajectory data, the wandering behaviors of the ship are classified, and the relationships between the movement trajectories of the four typical ship abnormal movement behaviors and the defined variables are summarized According to the analysis on the relationships between the characteristics of the movement trajectories of the ship and the statistical parameters, the abnormal wandering behaviors of the ship are detected according to the distribution of the trajectories in the grids. After the AIS trajectories of the ship are filtered and smoothed, a global space-time grid index is established, and the trajectories of the ship are gridded, and abnormal movements of the ship are detected according to the characteristics of the trajectories of the abnormal behaviors of the ship, and an abnormal classification alarm is given for the abnormal trajectories of the movement behaviors of the ship. The ship wandering detection method is applicable to the field of big data analysis, and the detection for the wandering behaviors of the ship can provide decision support for maritime safety supervision, so as to enhance the safety of maritime traffic and ensure the safe navigation of the ship, which has great significance to promote the safety, efficiency and smoothness of maritime transportation.

### BRIEF DESCRIPTION OF DRAWINGS

FIG. 1 is diagrams of trajectories of several typical wandering movement behaviors; and

FIG. 2 is a schematic diagram of ship wandering detection results of the present invention.

### DETAILED DESCRIPTION OF THE EMBODIMENTS

The present invention is further described hereinafter in combination with the drawings:

In the present invention, it is assumed that the quantities of rows and columns of space grids are p and q respectively in a research area, and correlated variables need to be defined before an abnormal wandering behavior of a ship is identified:

(1) A grid counting variable n (u, v) which is the quantity of tracing points included in the grids is defined. u represents the row number of the grids, and v represents the column number of the grids. In n (u, v), 0 is a default; and when the tracing points fall into the grids is inquired, the grid counting variable is changed correspondingly. The grid counting variable represents the superposition degree of a trajectory in the grids; and if a sailing trajectory of a same ship in a certain time range is intersected or is denser, multiple tracing points are inquired in the grids.

(2) A valid grid quantity n (valid) is defined. If the counting variable of the grids in the research area is more than 0, the grids are the valid grids. In the research area, the quantity of the valid grids of all grids is the valid grid quantity which is expressed by n (valid), and the greater the valid grid number is, the higher the proportion of the trajectory of the ship in the whole research area is.

(3) If the valid grids with the counting variable of being more than 2 exist in the research area, the quantity of the type of grids is counted in a grid area range. n (>2) represents the quantity of the type of grids in the whole research area. The greater n (>2) is, the higher the superposition degree of the trajectory of the ship in the range is. As an abnormal behavior judgment is carried out on the movement trajectory of the ship, the greater the statistical variable is, the higher the probability of an abnormal behavior of the ship in the research area range is.

(4) A center grid O(ū, v̅) of the trajectory of the ship in the research area is defined. The row number and the column number of the valid grids are respectively averaged according to the following formula, so as to obtain a center point O(ū, v̅) of the trajectory, and the grids represent the approximate direction of the trajectory in the grid area.

$$\{ \begin{matrix}\overline{u} = \frac{Σ u}{n} \\ \overline{v} = \frac{Σ v}{n}\end{matrix} , {n}_{( u , v )} \neq 0 \qquad ( Formula 1 )$$

(5) The approximate cover area s of the trajectory of the ship in the research area is defined. A diagram formed by the trajectory of the ship is irregular, so that the cover area of the trajectory cannot be directly calculated by using the ranges of the row number and the column number of the trajectory. The approximate area s of the trajectory of the ship is calculated by adopting the following method in the present invention. Firstly, all valid grids in the research area are obtained; then the valid grids are traversed; the valid grids in the research area are scanned row by row, so as to obtain the column number of the valid grids in each row; the maximum column number minus the minimum column number is a trajectory range of the row; all trajectory ranges in the research area are added together to obtain the approximate area s1 of the trajectory; in order to ensure the accuracy of a research result, the valid grids are traversed column by column to obtain a trajectory range of each column, so as to obtain the approximate area s2 of the trajectory; the calculation results s1 and s2 are added together and then are averaged, so as to obtain the final approximate area s of the trajectory.

(6) The quantity ñ of non-valid grids in a k*k neighborhood near the center O(ū, v̅) of the trajectory is defined, which has an important auxiliary effect on judgment for the shape of the trajectory.

(7) The sum nₛᵤₘ of the counting variables is defined, and nₛᵤₘ represents the quantity of all grids, through which the trajectory passes, and is used for representing the length of the trajectory.

According to a movement trajectory behavior of the ship, when a non-fishing ship has a similar wandering behavior, the abnormal behavior is often related to drunk driving, hijacking, illegal fishing, piracy, illegal measurement and so on. Then the length of the trajectory in a certain range is apparently higher than the normal condition. Relationships between trajectories of four typical abnormal movement behaviors of the ship and the above defined variables are summarized. If the ship sails normally, the movement trajectory of the ship in a period of time should be that the change of the slope of the trajectory in the research area is more stable; and generally, the shape of the trajectory is not complex, the trajectory has no point of intersection or less points of intersection basically, and at the moment, the movement trajectory is a normal trajectory. If the trajectory has too many points of intersections in a time threshold range, and the trajectory is longer, the trajectory of the ship is considered as an abnormal movement at the moment. The ship wandering is specifically classified as follows:

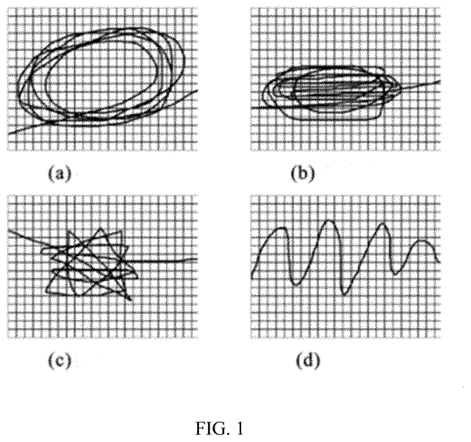

(1) An approximate elliptical movement. When the shape of the trajectory of the ship is approximate to an ellipse, the trajectory is judged as a trajectory of an abnormal movement as the trajectory is not a staying trajectory of the ship. When the ship has an approximate elliptical trajectory, it may be that the ship is conducting illegal detection. At the moment, the wandering trajectory of the ship has more points of intersection and higher superposition degree. At the moment, the valid grid quantity in the research area is larger, so the counting variables are also relatively larger. As the valid grid quantity in the trajectory range is very small, the approximate area of the trajectory is larger than the valid grid quantity, and n is also larger. The specific abnormal performance is shown in FIG. 1 (a).

(2) A back and forth movement. When the ship moves back and forth between two points at sea, the ship may be in drunk driving or suffered from some hijacking; at the moment, the valid grid quantity n (valid) of the ship is relatively smaller, but the counting variable n (u, v) of the ship is usually larger; the approximate area s of the trajectory of the ship is slightly different from the valid grid quantity n (valid), and the trajectory of the ship near the center of the trajectory of the ship is denser; and at the moment, the quantity of the non-valid grids in the neighborhood in a certain range of the center of the trajectory is smaller, and the specific performance is shown in FIG. 1 (b).

(3) An irregular movement. When the ship moves irregularly, it may be that the ship breaks down or a driver is in drunk driving. At the moment, the trajectory of the ship has fewer points of intersection in the time range; meanwhile, the valid grid quantity n (valid) is not small, but the n (u, v) of many valid grids is not large; and the approximate area s of the trajectory is larger than the valid grid quantity n (valid). However, if the time threshold is larger, the trajectory of the ship has more and more points of the intersection, the superposition rate of the trajectory is higher, and the shape of the trajectory in the grids may be close to the back and forth movement. The specific performance is shown in FIG. 1 (c).

(4) An S-shaped curve movement. At the moment, it may be that the ship is in illegal measurement at sea; the trajectory of the ship has no point of intersection, and n (valid) is smaller; and the approximate area s of the trajectory is larger than the valid grid quantity n (valid), and the count of most valid grids is 1. The specific performance is shown in FIG. 1 (d).

According to an analysis on relationships between the characteristics of the movement trajectory of the ship and statistical parameters, the abnormal wandering behaviors of the ship are identified according to the distribution of the trajectories in the grid diagrams. The specific algorithm comprises the following steps:

(1) acquiring a space range of a key research area, i.e. a longitude and latitude range, wherein generally, the key research area is a rectangular area, and the longitude and the latitude of four angular points of the rectangle are acquired; and after the space range of the key research area is determined, the time range is 1 day by fault, and the beginning time and the ending time are input to start the identification for abnormal data of the movement trajectory of the ship in the period of the time;

(2) calculating a grid code area covered by the space range according to the longitude and the latitude of the space range after the space range of the key research area is determined and obtaining a grid code set (u₁, u₂, . . . , uₙ) in the space range;

(3) calculating and outputting a row and column number range ({uminₘₐₓ, {vminₘₐₓ)}} according to the grid code range;

(4) screening original movement trajectories of the ship, acquiring trajectory data in a set time range and a set space range and converting a result data set into a corresponding grid code set;

(5) traversing the grid code set of the movement trajectory of the ship and counting the valid grid quantity nValid in the set; judging that whether grid codes in the set have repeating value, and if the same codes exist in different time nodes, adding 1 into the count of the grids; and outputting a result set after the judging circulation is completed, wherein the length of the set is the valid grid quantity;

(6) determining the range (the grid code range (a valid counting variable is more than or equal to 1.)) of the valid grids in each row according to the row and column number range and calculating the approximate area s; acquiring the code range in the range of each row, finding out the maximum value and the minimum value of the valid counting variable n, calculating the difference between the maximum u and the minimum u in each row, adding 1 into the difference and summing results of all rows to obtain the approximate area sₐᵣₑₐ calculated according to the rows; then, calculating the grids in each column in the research area in the same manner, acquiring a calculation result of each column and summing the calculation results to obtain the approximate area s_{areac} of the trajectory, which is calculated according to the columns; and finally, obtaining the approximate area which is an average value of the above two approximate areas;

s=(sₐᵣₑₐₗ+s_{areac})/2 (Formula 2)

(7) calculating the row number and the column number of the center of the trajectory by the grid codes of the trajectory of the ship, determining the grid code of the center of the trajectory and auxiliarily judging the specific shape of the trajectory;

(8) calculating the length of the trajectory, wherein the total length of the movement trajectory of the ship is the sum of all valid grid counting variables; and

(9) generally, the length nₛᵤₘ of the trajectory of the ship, which is generated by normal behaviors such as taking the turning, passing through a key area, moving back along the original road and the like in the sailing process, is less than twice the sum of the quantities of rows and columns of the grids in the space range of the key area; if nₛᵤₘ is more than the threshold, judging that the trajectory is an abnormal trajectory; when the quantity n_{(>2)} of the grids with the valid counting variable more than 2 is more than twice the sum of the quantities of rows and columns of the grids in the space range of the key area, judging that the ship is doing repeated back and forth movements or the approximate elliptical movement possibly; when the quantity n_{(>2)} of the grids with the valid counting variable more than 2 is equal to 0, judging that the ship is doing the approximate S-shaped curve movement possibly; when ñ is more than 15, and s−n (valid) is more than 20, judging that the trajectory is the elliptical trajectory possibly; when ñ is less than 8, and s−n (valid) is less than 10, judging that the trajectory is the back and forth trajectory possibly; when the length nₛᵤₘ of the trajectory of the ship is equal to n (valid), determining that the trajectory is the approximate S-shaped curve; and if the length nₛᵤₘ of the trajectory of the ship is more than twice the sum of the quantities of rows and columns of the grids in the space range of the key area, but does not belong to the above situations, when n (valid) is more than (p+q)/4, judging that the ship is doing the irregular broken line movement.

In the sailing process of the ship, the 100*100 grids are taken as an example. If the movement trajectory of the ship meets a classification detection result, a related early warning is given to a manager. The specific rule of the above detection algorithm is described as follows:

when nₛᵤₘ−n (valid) is more than 2(p+q), the grid quantity (n_{(u,v)}≥3) is more than (p+q)/2, ñ is more than 15, and s−n (valid) is more than 20, the ship is doing the approximate elliptical movement;

when the nₛᵤₘ−n (valid) is more than 2(p+q), the grid quantity (n_{(u,v)}≥3) is more than (p+q)/2, ñ is less than 8, and s−n (valid) is less than 10, the ship is doing the back and forth movement;

when the nₛᵤₘ−n (valid) is more than 100, ñ is less than 8, and s is more than 80, the ship is doing the broken line movement;

when the nₛᵤₘ−n (valid) is less than 5, the grid quantity (n_{(u,v)}≥3) is equal to 0, and s/n (valid) is more than 1.5, the ship is doing the S-shaped curve movement; and

when the trajectory does not meet the above situations, but nₛᵤₘ is more than 400, a moving object has an abnormal movement behavior.

Firstly, an AIS trajectory data table of the ship is taken as an example to explain the trajectory segmentation process of the ship.

TABLE 1
AIS Data of Trajectory of Ship

| MMSI | BaseDateTime | LAT | LON | SOG | COG |
|---|---|---|---|---|---|
| 367505650 | 2017 Dec. 18 01:40:25 | 0.0073 | −90.47 | 3.9 | −156 |
| 367505650 | 2017 Dec. 18 01:40:45 | 0.0075 | −90.47 | 3.6 | −156.4 |
| 367505650 | 2017 Dec. 18 01:41:05 | 0.0076 | −90.48 | 3.8 | −156.3 |

MMSI represents a maritime communication identification code of the ship, BaseDateTime represents the signal emission time of an AIS, LAT represents the latitude, LON represents the longitude, SOG represents the sailing speed, and COG represents the sailing direction of the ship.

Step 1, performing data reading, reading all AIS data of an input data source, selecting the trajectory data in the longitude and latitude range (132W-130W, 54N-56N) of the research area and the certain time range (Dec. 1, 2017-Dec. 31, 2017) in a database, wherein after the space range of the key research area is determined, the time range is 1 day by fault, and the identification for the abnormal data of the movement trajectory of the ship in the period of the time is started according to the time range and the space range;

Step 2, calculating the grid code area covered by the space range according to the longitude and the latitude of the space range after the space range of the key research area is determined and obtaining the grid code set (u₁, u₂, . . . , uₙ) in the space range;

Step 3, segmenting the trajectory of the ship and identifying the staying trajectory of the ship and the movement trajectory of the ship, so as to obtain the trajectory of the movement behavior of the ship;

Step 4, calculating and outputting the row and column number range {(uminₘₐₓ, {vminₘₐₓ)}} according to the grid code range; and screening the original movement trajectories of the ship, acquiring the trajectory data in the set time range and the set space range and converting the result data set into the corresponding grid code set;

Step 5, traversing the grid code set of the movement trajectory of the ship and counting the valid grid quantity nValid in the set; judging that whether the grid codes in the set have repeating value, and if the same codes exist in different time nodes, adding 1 into the count of the grids; and outputting the result set after the judging circulation is completed, wherein the length of the set is the valid grid quantity;

Step 6, determining the range (the grid code range (the valid counting variable is more than or equal to 1.)) of the valid grids in each row according to the row and column number range and calculating the approximate area s; acquiring the code range in the range of each row, finding out the maximum value and the minimum value of the valid counting variable n, calculating the difference between the maximum u and the minimum u in each row, adding 1 into the difference and summing the results of all the rows to obtain the approximate area sₐᵣₑₐ calculated according to the rows; then, calculating the grids in each column in the research area in the same manner, acquiring the calculation result of each column and summing the calculation results to obtain the approximate area s_{areac} of the trajectory, which is calculated according to the columns; and finally, obtaining the approximate area which is an average value of the above two approximate areas;

s=(sₐᵣₑₐₗ+s_{areac})/2 (Formula 2)

Step 7, calculating the row number and the column number of the center of the trajectory by the grid codes of the trajectory of the ship, determining the grid code of the center of the trajectory and judging the specific shape of the trajectory; and

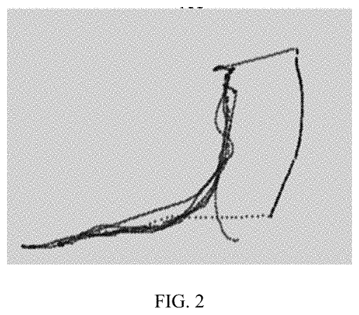

Step 8, detecting wandering behaviors of the ship, acquiring trajectory sections of the wandering behaviors of the ship and outputting the trajectory sections of the wandering behaviors of the ship, so as to obtain a result that the wandering behavior of the ship is the approximate elliptical movement, which is shown in FIG. 2.

The basic principle, main features and advantages of the present invention are shown and described above. Those skilled in the art should understand that the present invention is not limited by the above embodiments, and the above embodiments and the descriptions in the description are only used for explaining the principle of the present invention; and various changes and improvements can be made to the present invention without departing from the spirit and scope of the present invention, and the changes and improvements belong to the required protection scope of the present invention. The required protection scope of the present invention is defined by the appended claims and the equivalents thereof.

What is claimed is:

1. A ship wandering detection method based on AIS data, comprising the following steps:
S1: acquiring a space range of a key research area, i.e. a longitude and latitude range;
S2: calculating a grid code area covered by the space range according to the longitude and the latitude of the space range after the space range of the key research area is determined and obtaining a grid code set in the space range;
S3: calculating and outputting a row and column number range according to the grid code range;
S4: screening original movement trajectories of the ship, acquiring trajectory data in a set time range and a set space range and converting a result data set into a corresponding grid code set;
S5: traversing the grid code set of the movement trajectory of the ship and counting the valid grid quantity nValid in the set;
S6: determining the range of the valid grids in each row according to the row and column number range, i.e., the grid code range with a valid counting variable more than or equal to 1, and calculating the approximate area s;
S7: calculating the row number and the column number of the center of the trajectory by the grid codes of the trajectory of the ship, determining the grid code of the center of the trajectory and auxiliarily judging the specific shape of the trajectory;
S8: calculating the length of the trajectory, wherein the total length of the movement trajectory of the ship is the sum of all valid grid counting variables; and
S9: the length nₛᵤₘ of the trajectory of the ship is less than twice the sum of the quantities of rows and columns of the grids in the space range of the key area; and if nₛᵤₘ is more than the threshold, judging that the trajectory is an abnormal trajectory.

2. The ship wandering detection method based on AIS data according to claim 1, wherein the step S5 comprises: judging that whether grid codes in the set have repeating value, and if the same codes exist in different time nodes, adding 1 into the count of the grids; and outputting a result set after the judging circulation is completed, wherein the length of the set is the valid grid quantity.

3. The ship wandering detection method based on AIS data according to claim 1, wherein the step S6 comprises acquiring the code range in the range of each row, finding out the maximum value and the minimum value of the valid counting variable n, calculating the difference between the maximum u and the minimum u in each row, adding 1 into the difference and summing results of all rows to obtain the approximate area sₐᵣₑₐ calculated according to the rows; then, calculating the grids in each column in the research area in the same manner, acquiring a calculation result of each column and summing the calculation results to obtain the approximate area s_{areac} of the trajectory, which is calculated according to the columns; and finally, obtaining the approximate area which is an average value of the two approximate areas: s=(sₐᵣₑₐₗ+s_{areac})/2.

4. The ship wandering detection method based on AIS data according to claim 1, wherein in the step S9, when the quantity n_{(>2)} of the grids with the valid counting variable more than 2 is equal to 0, judging that the ship is doing the approximate S-shaped curve movement possibly; when ñ is more than 15, and s−n (valid) is more than 20, judging that the trajectory is the elliptical trajectory possibly; when ñ is less than 8, and s−n (valid) is less than 10, judging that the trajectory is the back and forth trajectory possibly; when the length nₛᵤₘ of the trajectory of the ship is equal to n (valid), determining that the trajectory is the approximate S-shaped curve; and if the length nₛᵤₘ of the trajectory of the ship is more than twice the sum of the quantities of rows and columns of the grids in the space range of the key area, but does not belong to the above situations, when n (valid) is more than (p+q)/4, judging that the ship is doing the irregular broken line movement.
